(19) United States
(12) Patent Application Publication
(10) Pub. No.: US 2011/0119745 A1
(43) Pub. Date: May 19, 2011

(54) NETWORK AUTHENTICATION

(75) Inventor: Duncan Bremner, Renfrewshire (GB)

(73) Assignee: ITI SCOTLAND LIMITED, Glasgow, Scotland (GB)

(21) Appl. No.: 12/600,594

(22) PCT Filed: May 9, 2008
(86) PCT No.: PCT/GB2008/001619

§ 371 Date: Dec. 3, 2010

(30) Foreign Application Priority Data
May 24, 2007 (GB) 0710017.5

(51) Int. Cl. H04L 9/32; G06F 21/00

(52) U.S. Cl. 726/7

(57) ABSTRACT

There is provided a Security Manager Device for allowing the secure establishment of network connections between devices, the Security Manager Device comprising a memory for storing network authentication information for a network and a transmitter for wirelessly transmitting the stored network authentication information to a device to be connected to a second device.

### TECHNICAL FIELD OF THE INVENTION

The invention relates to the secure authentication of client devices with a network.

### BACKGROUND TO THE INVENTION

The authentication, authorisation and administration of network devices is crucial to managing network security and is becoming a greater burden to the user as networks increase in both security and complexity.

Authentication describes the passing of information between a client device and a network which identifies the client to the network. Authorisation describes the granting of permission by the network for a client to join the network and assignment of levels of access to files or services. Administration describes the management activities which control who or what may be authorised to join the network and control the activities or levels of access to files or services permitted.

With the advent of wireless networking, the requirement of authenticating and authorising a client device securely with a wireless network has become more important. There is a requirement, not only to secure the communication traffic between the client device and the network, but also to positively establish that the client device is accessing the correct wireless network, as often there may be several wireless networks operating in a particular location.

In existing wireless network protocols, such as Bluetooth, a ‘pairing’ procedure is invoked by engaging both ‘ends’ of the network (i.e. the client device wishing to join, and the device forming part of the network infrastructure, such as a server or host). This approach satisfies the above requirements for both network security and unambiguous client identification, as only the specific client device will be engaged in the pairing procedure. The procedure itself results in the establishment of a secure connection between the client device and host device because both ends of the connection must participate in the pairing procedure. However, if the network is being shared amongst several users, this type of pairing procedure is inappropriate and difficult to manage.

A different implementation has been adopted by the wireless local area network (W-LAN) industry in which a shared key (known as a WEP key) must be correctly entered by the client device so that it may join the network. However, this method of authentication could be compromised as the network key can be stolen. Additionally, it does not ensure a definitive network connection as it is carried out over the wireless channel (however a different type of key, known as a WPA key, does improve this). In addition, entering the network key requires direct physical access to the device (which could be, for example, a ceiling mounted projector), and requires the presence of a keypad and/or simple screen on the device, adding costs to existing consumer electronic devices.

Furthermore, in this type of system, it is not possible to ensure that the correct client device (from the network's point of view) or network (from the client device's point of view) is being authenticated, as no physical connection is provided between the client device and network, which is the only known method of ensuring that a device ‘A’ joins a network ‘B’.

In some solutions to this problem, in order to positively identify the joining client with a specific network, the physical ‘pairing’ between the client device and the host device in the target network is enabled via a temporary wired connection. In yet other implementations, the two devices are positively identified by the simultaneous pushing of a pairing button. Although this method of authentication guarantees that the correct two devices are ‘paired’, it still requires physical access to both devices.

None of these implementations are easy for larger networks, thus, there is a need for an authentication method that allows the information to be transferred quickly and securely between client devices and the host network that enables clients to wirelessly join a given network, with a simple user interface.

### SUMMARY OF THE INVENTION

In accordance with a first aspect of the invention, there is provided a Security Manager Device comprising a memory for storing network authentication information for a network, and a transmitter for wirelessly transmitting the stored network authentication information to a device to be connected to a second device.

According to a further aspect of the invention there is provided a device comprising a receiver for receiving network authentication information for a network wirelessly from a Security Manager Device, the device being adapted to connect to a second device using the received network authentication information.

According to a further aspect of the invention, there is provided a method comprising the step of transmitting network authentication information wirelessly from a Security Manager Device to a device to be connected to a second device.

### BRIEF DESCRIPTION OF THE DRAWINGS

The invention will now be described, by way of example only, with reference to the following drawings, in which:

FIG. 1 is a block diagram of a wireless network in accordance with the invention;

FIG. 2 is a block diagram of a Security Manager Device in accordance with an embodiment of the invention;

FIG. 3 is a block diagram of a generic client device in accordance with an embodiment of the invention;

FIG. 4 is a flow chart of a method of configuring a Security Manager Device in accordance with an embodiment of the invention; and

FIG. 5 is a flow chart of a method of establishing a network in accordance with an embodiment of the invention.

### DETAILED DESCRIPTION OF THE PREFERRED EMBODIMENTS

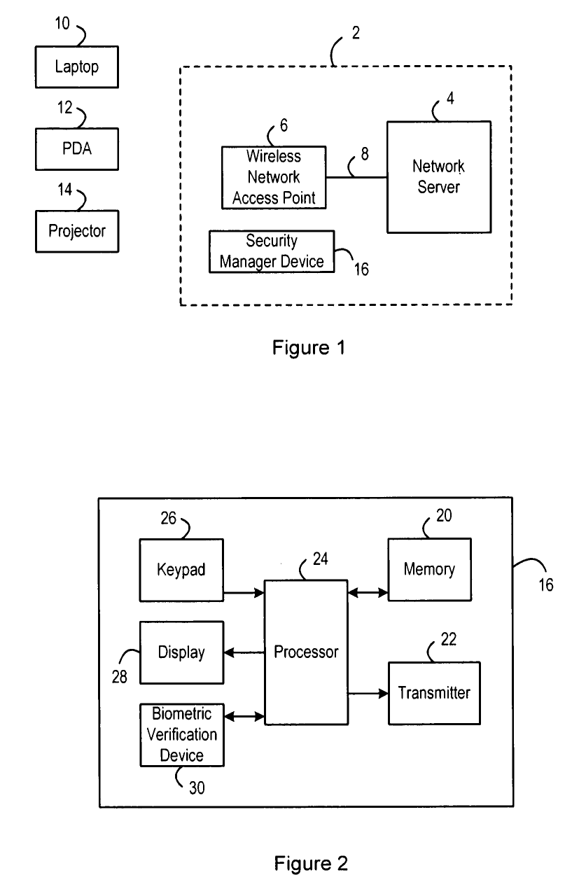

FIG. 1 shows a block diagram of a wireless network to be set up in accordance with the invention. The wireless network 2 comprises a network server 4 which will administrate and control the wireless network 2, as is well known in the art. Although the administrative and control server is shown as a centralised unit, it is entirely feasible to utilise a distributed implementation of this function. A wireless network access point 6 is connected to the network server 4 via a wired connection 8, and provides the means by which client devices 10, 12 and 14 can be connected wirelessly to the network 2. It will be appreciated that the network server 4 may instead be connected to the wireless network access point 6 via a wireless connection. Although the invention contained within this application is particularly applicable to wirelessly connected devices, it is equally applicable to a wired network. In this illustrated embodiment, the client devices comprise a laptop 10, a personal digital assistant 12 and a ceiling mounted projector 14.

As described above, when one of the client devices 10, 12 or 14 wishes to connect to the wireless network 2 for the first time, conventional methods require that either both the client device 10, 12 or 14 and the wireless network access point 6 are engaged in a pairing procedure (requiring the user to have direct physical contact with both devices) or it is necessary to manually enter a predetermined network key into the client device 10, 12 or 14 (requiring the user to have direct physical contact with the client device, and also a suitable input means on the client device for the network key to be entered).

However, in accordance with the invention, a Security Manager Device 16 is provided which allows network authentication information, such as a network identifier and a network key, to be provided to the client device, without the user requiring direct physical contact with the client device. In one embodiment, the network authentication information, which is stored in the Security Manager Device 16, can be provided to the client device using a light source, such as a coherent or non-coherent light source (including a laser) or simply modulated light beam (for example in the visible or infra-red spectrums), and in an alternative embodiment, it can be provided using near-field transmission technology. Alternatively, it will be appreciated that any other suitable wireless communication technology can be used.

Due to the simple method of focussing the light beam, or otherwise carefully controlling the range of the wireless transmission, line-of-sight or very close range is required from the Security Manager Device 16 to the client device 10 (in the case of using modulated or laser light), or as the Security Manager Device 16 must be in very close proximity to the client device 10 (in the case of using near-field transmission technology), the user can positively confirm that the client device 10 is being provided with information relating to the correct network 2.

FIG. 2 shows a block diagram of a Security Manager Device 16 in accordance with the invention. The Security Manager Device 16 comprises a memory 20 for storing the network authentication information for the network 2, an appropriate transmitter 22 for transmitting the network authentication information to the client device (10, 12, 14) and a processor 24 for controlling the operation of the Security Manager Device 16.

In this illustrated embodiment, the Security Manager Device 16 further comprises a keypad 26 for receiving inputs from a user of the Security Manager Device 16, such as new network authentication information or a PIN to authorise the user, a display 28, and some verification means 30 for verifying that the user is authorised to use the Security Manager Device 16. Preferably, the verification means 30 is a biometric verification means 30 which comprises at least one type of biometric sensor, such as a fingerprint reader, iris scanner, etc.

In further embodiments, the Security Manager Device 16 can comprise an external input/output interface, such as a USB interface, for use in receiving new network authentication information from a server or host 4. The external input/output interface can also be used to connect the Security Manager Device 16 directly to a client device 10 if that client device does not support receiving network authentication information wirelessly in the manner described herein, or if the client device 10 is easily accessible and the network administrator or other user of the Security Manager Device 16 wishes to use a direct physical connection to transfer the network authentication information.

Preferably, the Security Manager Device 16 is a small handheld device, and is sized so that it can be attached to a key ring or similar. In particular embodiments, the Security Manager Device 16 could resemble a key fob, laser pen or memory card in form or shape.

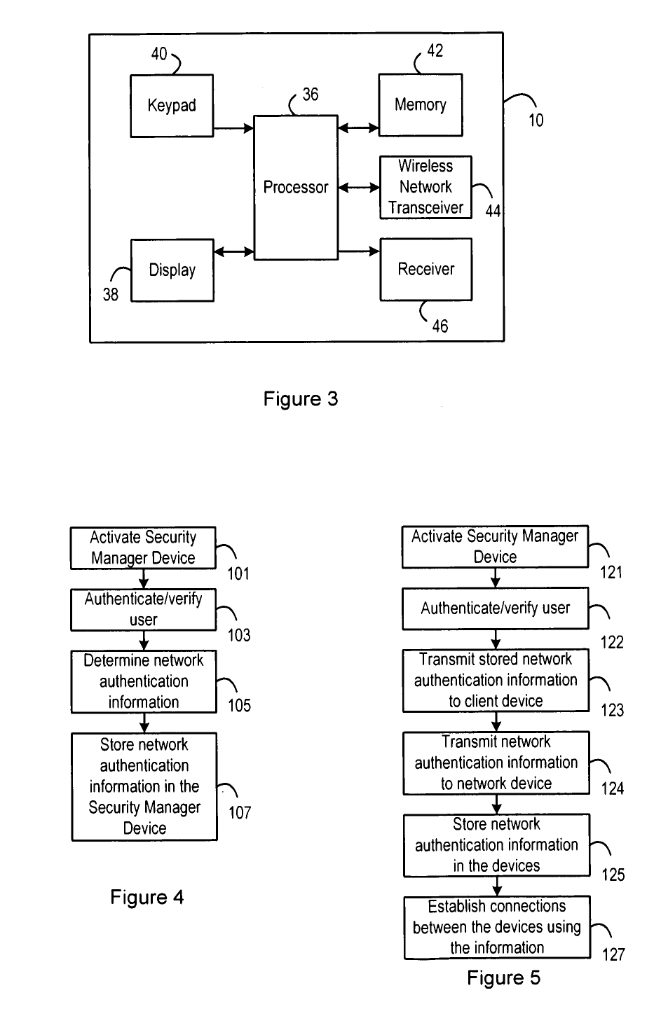

FIG. 3 shows a client device 10 in accordance with an embodiment of the invention. As described above, this client device 10 could be a laptop, which comprises a processor 36, a display 38, keypad or keyboard 40, a memory 42 and a wireless network transceiver 44. The wireless network transceiver 44 can comprise a transceiver adapted for use in any suitable network, such as a W-LAN, Bluetooth or any other common wireless network. In accordance with the invention, the client device 10 also comprises a receiver 46, which is of a suitable type to receive the network authentication information from the transmitter 22 in the Security Manager Device 16. Thus, if the transmitter 22 uses infrared or visible light, the receiver 46 will comprise a suitable light sensor. It should be pointed out that in the majority of networked devices, a light sensor, such as an infra-red remote control signal sensor, is already built in the device.

Host devices 4, such as network servers, can have the same basic structure as the client device 10, 12 or 14 shown in FIG. 3.

FIG. 4 shows a method of configuring the Security Manager Device 16 in accordance with an embodiment of the invention. In step 101, the Security Manager Device 16 is activated, such as by pressing a ‘power’ button or similar. In step 103, the identity of the user of the Security Manager Device is authenticated or verified. This can be carried out by the user entering an appropriate PIN into the keypad 26 of the Security Manager Device 16, or by determining biometric data for the user and comparing this with previously determined biometric data stored in a memory 20 of the Security Manager Device 16. Once the identity of the user has been confirmed, the method passes to step 105 in which the network authentication information is determined.

As described above, the network authentication information can comprise information such as a network identifier, a network key, various settings for the network, such as radio frequency used, radio transmission format, etc., with the exact type of information being determined by the type of network the Security Manager Device 16 is to be used with. The information can be determined by the user of the Security Manager Device 16 entering it into the Security Manager Device 16 using the keypad 26 based on settings or information already present in an established wireless network 2, or desired for a network that is to be established. Alternatively, if the Security Manager Device 16 comprises an external input/output interface, the information can be transferred to the Security Manager Device 16 from another electronic device, such as a personal computer, via this interface.

It will be appreciated that the information stored on the Security Manager Device 16 can be encrypted or protected in a way that prevents the recovery of the information if the Security Manager Device 16 is stolen. Any suitable techniques can be used (including a PIN).

In one embodiment of the invention, the Security Manager Device 16 may also include a security level for the identified user, which indicates the level of access that that user is permitted to the network, and/or the level of administrative privileges that the user has in setting up network connections between devices. For example, a user that has the highest level of security (such as an administrator) might be able to use the Security Manager Device 16 to set up whole networks (i.e. provide the network authentication information to any type of device), to modify the network authentication information as required, etc. A user that has the lowest level of security (such as a visiting user of the network) might only be able to use the Security Manager Device 16 to set up one particular type of connection (such as between their particular client device and the network) or only be able to modify their particular PIN or other identity information.

In a further embodiment, the level to which the user of the Security Manager Device 16 is verified (i.e. is a PIN or a stronger biometric identifier required) depends on the level of security of the user. Thus, a low security level user of the Security Manager Device 16 may only be required to enter a simple PIN, while a high security level user (such as a network administrator) may be required to enter biometric information or a complex PIN. Such methods of using several different keys or information to access a network, such as “Perfect Secret” keys, are well known to a person skilled in the art.

In a further embodiment of the invention, the step of determining the network authentication information can comprise determining the network key (i.e. the key or pass phrase used to access the network or to encrypt communications in the network) by combining a ‘standard’ network key (i.e. a pass phrase or a random selection of characters) with information specific to the user of the Security Manager Device 16, such as their PIN or information derived from their biometric profile to form a final authentication key. Methods for carrying out this combination are well known in the art This final transfer of the authentication key can then be used by devices to access the network and/or to encrypt communications. This authentication key allows the user of the Security Manager Device 16 to ensure that the client device(s) connect to the correct network 2, since the key will be substantially unique to the user and resulting host and/or client devices.

Once the network authentication information has been determined, the method passes to step 107 in which the network authentication information is stored in the memory 20 of the Security Manager Device 16.

FIG. 5 is a flow chart showing a method of using the Security Manager Device 16 to establish a new network 2 between a plurality of devices including a host device 4, such as a network server, and at least one client device 10, 12 or 14. In step 121, the Security Manager Device 16 is activated, such as by pressing a ‘power’ button or similar. In step 122, the identity of the user is verified, as described with reference to step 103 above.

When the identity of the user of the Security Manager Device 16 is verified, then, in step 123, the network authentication information determined and stored in the memory 20 of the Security Manager Device 16 in accordance with the method shown in FIG. 4 is transmitted to each of the plurality of devices in turn. As described above, the network authentication information is transmitted from the Security Manager Device 16 using the transmitter 22, which may comprise a visible or infra-red modulated light source, or a near-field wireless communication transmitter. Thus, the Security Manager Device 16 must be pointed at a receiver 46 on each of the devices (10, 12 or 14) in turn in the case of the transmitter 22 being a visible or infra-red light source, or must be placed in close proximity to the devices 10 in the case of the transmitter 22 using near-field communication technology.

If the host device 4 in the new network does not yet have the network authentication information for the new network (for example if the user inputs the network authentication information directly into the Security Manager Device 16), the Security Manager Device 16 can be used to transmit the network authentication information to the host device 4 in the same way as for a client device 10 (step 124).

Thus, it is possible by this means to establish a secure network comprising completely new devices (including the host devices in the case of a centralised network) by using only the information held on the Security Manager Device 16.

In step 125, the network authentication information is stored in the host and client devices.

In step 127, the host device 4 establishes connections with each of the client devices 10 in turn using the received network authentication information, and in accordance with the usual procedures used in the type of network supported by the host and client devices 4 and 10, 12 or 14.

Thus, as the network authentication information is provided to the client devices 10, 12 and 14 wirelessly, and without the user being required to be in physical contact with the client devices, the Security Manager Device 16 allows wireless connections and wireless networks to be established quickly and easily.

For example, consider adding a number of new devices to an existing WLAN network. The Security Manager Device 16 can be set up with a network ID (say “CompanyName”) and a network password (say “Secret1”). Then, after transfer of this information to each of the new devices, the devices can establish the appropriate connections using the information. Thus, the Security Manager Device 16 does not participate in any of the actual data signalling between the devices.

The Security Manager Device 16 in accordance with the invention can be used in the same way as described with reference to FIG. 5 to add new permanent or temporary client devices 10, 12 and 14 to an existing network 2. In this case, the Security Manager Device 16 will have the appropriate network authentication information for the existing network 2 stored in memory 20 (which has either been received from the host device 4 or manually entered by the user of the Security Manager Device 16), and it is transmitted to the new client device 10, 12 or 14 using the transmitter 22.

In some embodiments, the network authentication information can comprise information that is specific to the new client device 10, such as a service level (including bandwidth, download/upload limits, priority for accessing the network 2, an access credit level which can be used as electronic currency for payment to commercial wireless networks, a unique ID code, etc) to be provided to that client 10. This device-specific service level information can comprise an access code in the network authentication information associated with the appropriate service level. Different service levels can be provided based on whether the user of the client device is a known subscriber or member of the network 2, or if the user is a temporary visitor to the network 2.

It is also possible for the network authentication information to be changed over time (including changing a specified service level for a client device 10). In this case, the Security Manager Device 16 can be used to transfer this new network authentication information to client devices 10, 12 and 14, even if these devices are already connected to the network 2. In this case, once new network authentication information is received, the client device 10 can adjust the connection parameters appropriately, or reconnect to the network 2 using the new information.

By using optical means to transmit the network authentication information, the Security Manager Device 16 can be pointed at client or host devices from a distance, and the network authentication information can be communicated in a secure manner by illuminating a receiver device mounted on or in the device to be added to the network (such as a projector, access point, etc). Thus, client devices are positively identified by illuminating the appropriate point on the client device with the Security Manager Device 16.

The Security Manager Device 16 allows new networks to be set up wirelessly, by removing the need to directly enable each client device by entering the network authentication information manually via a key pad or similar physical human-machine interface.

1. A Security Manager Device, comprising:
a memory for storing network authentication information for a network; and
a transmitter for wirelessly transmitting the stored network authentication information to a device to be connected to a second device.

2. A Security Manager Device as claimed in claim 1, wherein the transmitter comprises a light source for illuminating a receiver on the device to be connected to the network.

3. A Security Manager Device as claimed in claim 2, wherein the light source comprises a modulated or laser light source.

4. A Security Manager Device as claimed in claim 2, wherein the light source emits visible light.

5. A Security Manager Device as claimed in claim 2, wherein the light source emits infrared light.

6. A Security Manager Device as claimed in claim 1, wherein the transmitter comprises a near-field wireless communication transmitter.

7. A Security Manager Device as claimed in claim 1, further comprising a verification device for verifying the identity of a user of the Security Manager Device.

8. A Security Manager Device as claimed in claim 7, wherein the verification device is a biometric verification device.

9. A Security Manager Device as claimed in claim 7, further comprising processing means adapted to use a user input to the verification means to determine at least a part of the network authentication information.

10. A Security Manager Device as claimed in claim 1, wherein the network authentication information comprises at least one of a network identity, a network key and a service level for a user.

11. A Security Manager Device as claimed in claim 1, further comprising input means adapted to allow a user to enter the network authentication information into the Security Manager Device.

12. A Security Manager Device as claimed in claim 1, further comprising an input/output interface for receiving the network authentication information from a host device.

13. A device, comprising:
a receiver for receiving network authentication information for a network wirelessly from a Security Manager Device;
the device being adapted to connect to a second device using the received network authentication information.

14. A device as claimed in claim 13, wherein the receiver comprises a light sensor.

15. A device as claimed in claim 14, wherein the light sensor comprises a modulated or laser light sensor.

16. A device as claimed in claim 14, wherein the light sensor is adapted to sense visible light.

17. A device as claimed in claim 14, wherein the light sensor is adapted to sense infrared light.

18. A device as claimed in claim 13, wherein the receiver comprises a near-field wireless communication receiver.

19. A device as claimed in claim 13, further comprising:
a wireless network transceiver for establishing a connection with the second device using the received network authentication information.

20. A device as claimed in claim 13, wherein the device is a host device.

21. A device as claimed in claim 13, wherein the device is a client device.

22. A device as claimed in claim 13, wherein the network authentication information comprises at least one of a network identity, a network key and a service level for a user.

23. A method, comprising:
transmitting network authentication information wirelessly from a Security Manager Device to a device to be connected to a second device.

24. A method as claimed in claim 23, further comprising:
using the network authentication information received by the device to connect the device to a second device.

25. A method as claimed in claim 23, wherein the step of transmitting network authentication information comprises transmitting the information using a light source in the Security Manager Device and illuminating a light sensor on the device to be connected to the network.

26. A method as claimed in claim 25, wherein the light source comprises a modulated or laser light source.

27. A method as claimed in claim 25, wherein the light source emits visible light.

28. A method as claimed in claim 25, wherein the light source emits infrared light.

29. A method as claimed in claim 25, wherein the step of transmitting network authentication information comprises transmitting the information using a near-field wireless communication transmitter in the Security Manager Device to a corresponding receiver in the device to be connected to the network.

30. A method as claimed in claim 23, further comprising verifying the identity of a user of the Security Manager Device before the transmitting the network authentication information to the device.

31. A method as claimed in claim 30, wherein the step of verifying comprises verifying biometric information of the user of the Security Manager Device.

32. A method as claimed in claim 30, further comprising using a user input from the step of verifying to determine at least a part of the network authentication information.

33. A method as claimed in claim 23, wherein the network authentication information comprises at least one of a network identity, a network key and a service level for a user.
